(19) United States
(12) Patent Application Publication
(10) Pub. No.: US 2020/0302456 A1
(43) Pub. Date: Sep. 24, 2020

(54) Consensus Engine via Application Interactions

(71) Applicants: Alyx Baldwin, (US); Rachel Cheok Chee Law, (US)

(72) Inventors: Alyx Baldwin, Orange, CA (US); Rachel Cheok Chee Law, Orange, CA (US)

(21) Appl. No.: 16/357,997

(22) Filed: Mar. 19, 2019

(51) Int. Cl. G06Q 30/02; G06F 16/9536; H04L 12/58

(52) U.S. Cl. CPC G06Q 30/0203; H04L 51/18; H04L 51/046; G06F 16/9536

(57) ABSTRACT

Computer implemented methods and systems for determining a consensus for a group event and for determining a consensus based on automated interactions and suggestions. Computer implemented methods and systems to determine what occurs at a consensus event, selecting a location for the event, inviting users to participate in the event, selecting a provider for the event, selecting items for the event, paying for the event, and combinations thereof.

### BACKGROUND

This invention relates generally to determining a consensus for a group event and more particularly determining consensus based on automated interactions and suggestions.

Determining a consensus between groups of people when each group member has unique preferences is difficult. Every person has experienced the situation where a group of people spends countless time deciding where to go for lunch, what to do on vacation, or what to watch on TV. As client devices become more pervasive, electronic applications that associate groups of people may be used to streamline the process of generating a consensus.

### BRIEF DESCRIPTION OF THE DRAWINGS

FIG. 1 shows a computing environment for generating a consensus using a consensus module and consensus server, according to some embodiments.

FIG. 2 is a flowchart demonstrating the process of a consensus event in the computing environment, according to one embodiment.

FIG. 3 illustrates an interaction on a client device during the dietary preference sub-process, according to one embodiment.

FIG. 4 illustrates an interaction on the client device during the poll group sub-process, according to one embodiment.

FIG. 5 illustrates an interaction on the client device during the select provider sub-process, according to one embodiment.

FIG. 6 illustrates an interaction on the client device during the select menu items sub-process, according to one embodiment.

FIG. 7 illustrates a first additional interaction on the client device during the select menu items sub-process, according to one embodiment.

FIG. 8 illustrates a second additional interaction on the client device during the select menu items sub-process.

FIG. 8 illustrates a third additional chat interaction on the client device during the select menu items sub-process.

FIG. 9 illustrates an interaction on the client device during the confirm order sub-process.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

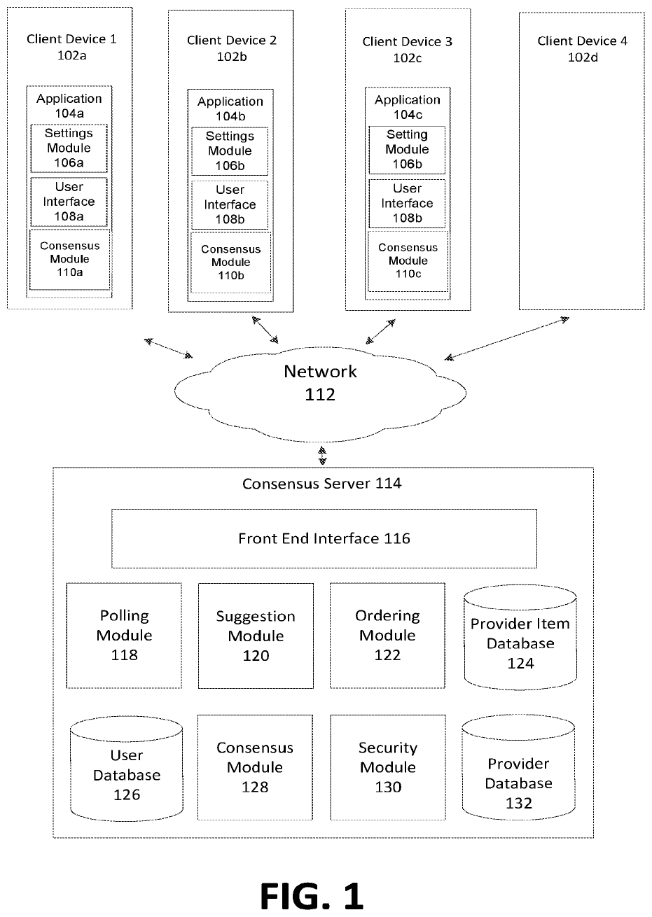

FIG. 1 shows an example computing environment 100 for generating a consensus using a consensus module, according to some embodiments. Within the environment, device users may want to reach a consensus about a topic using their client devices 102a-102d, e.g. where to go for lunch. The device users may have an application on their client device that can enable and simplify the process of reaching a consensus about the topic. The application 104 on each device 102 may monitor the inputs from the users into the user interface 108 using a consensus module 110. The consensus module 110 and consensus server 114 can initiate a ‘consensus event’ based on variety of triggers within the environment. The consensus event aids users in generating a consensus about the topic by directly questioning users, group polling users, and providing suggestions to users for any of the following aspects of the event: determining what occurs at the event (e.g. having a meal), selecting a location for the event (e.g. where to have lunch), inviting users to participate in the event (e.g. who to invite to lunch), selecting preferences for the event (e.g. what type of food), selecting of a provider for the event (e.g. the restaurant to order from), selecting items for the event (e.g. menu items to order), and paying for the event (e.g. sending payment information).

Within the environment 100 for the consensus event, a plurality of client devices 102a-102d provides a platform for an application 104 that enables communication between client device users on independent devices with similar applications 104a-104c. The client devices 102 include computing devices that can receive input from a user and can transmit and receive data via the network 112. A client device 102 communicates with the separate client devices and the consensus server 114 via the network 112. The operations of the devices 102 as described can be controlled through hardware, software, or a combination thereof. For example, client devices 102 may be a desktop computer, a laptop computer, a smart phone, a personal digital assistant (PDAs), or any other device including computing functionality and data communication capabilities.

The client devices 102 may also include software applications, such as application 104, which execute on the processor of the respective client device 102 to communicate with one another and with consensus server 114 during a consensus event. The application executing on the client device 102 is associated with a unique application identifier and performs various functions for interacting with other applications and for generating a consensus with the consensus server 114. Examples of such applications may be a web browser, a social networking application, a messaging application, a gaming application, and a media consumption application. Each application 104 may be linked to a user account on the consensus server 114 associated with a client device 102. In some embodiments the user account may be accessed via the front end interface 116 of the consensus server 114.

Each application 104 includes a settings module 106, a user interface 108, and a consensus module 110. The settings module 106 contains metadata and information associated with the device user, the client device, or a device user account. The metadata and information may be used by the environment 100 during a consensus event to streamline forming a consensus between the device users. In one embodiment, the information and metadata may be used to tailor interactions (e.g. questions, polls, suggestions) with the consensus module 110 to specific users and groups of users. This metadata and associated information can include: inter-device security metrics, network security metrics, authentication protocols, user account information and preferences, client device information and preferences, device user information and preferences, a record of preferences and changes, and location based information. For example, the settings module 106 may contain metadata as to the present location of each device 102 in a consensus event and may generate a suggestion for a provider based on the proximity of the devices to the provider.

The user interface module 108 includes input devices for data entry and output devices for display. The output devices may display content provided by the client device 102, the consensus server 114, or the user of the client device. The input devices may enable the user to take an action to interact with the application 104 or consensus server 114. These actions may include: typing, speaking, tapping, clicking, swiping, or any other input interaction. For example, a first device user using a first client device 102a may receive a text based message from a second device user using a second client device 102b via the network 112. The message is displayed on the first client device 102a with the user interface module 108a. The first user may type a reply message for the second user into the first client device 102a with the user interface module 108a to send to the second client device 102b via the network 112.

The consensus module 110 monitors and analyzes input from a user interacting with the application 104 on the client device for triggers of a consensus event. The triggers may be inputs from the users on the client device 102 (e.g. natural language text, text instructions, or icon interaction), inputs from users on the front end interface 116 of the consensus server 114, or settings on the settings module 106, etc. The consensus module 110 and consensus server 114 can initiate a consensus event that aids the users in generating a consensus. During the consensus event, the consensus module 110 may interact with the user and users to generate a consensus by questioning a user, polling users, suggesting to a user or users items, locations, or preferences for selection, and interpreting responses of any of the preceding interactions.

The consensus module 110 may be an application program interface (API) configured to operate within with the application 104. The API may specify how components of the device 102 and the application 104 interact with one another, with other devices, with the network 112, and with the consensus module server 114. As an example, the consensus module 110 may initiate communication with other devices in the environment 100, may provide information to display on the user interface 108, or access the settings module 106 during a consensus event. Additionally, the consensus module may be a standalone module or software application of the device 102 that interacts with the application 104. The consensus module 110 can monitor normal operation of the application 104 for triggers that will initiate specific functions of the API. The consensus module 110 may communicate with any module or database of the consensus server 114 to facilitate functionality of the consensus module 110, e.g. the consensus module 110 may access the provider item database 124 during a consensus event. The consensus module 110 may communicate with the consensus server 114 and server side consensus module 128 via the network 112 to facilitate monitoring and analyzing of user input.

The network 112 may comprise any combination of local area and/or wide area networks, the Internet, or one or more intranets, using both wired and wireless communication systems. In one embodiment, each of the components included in the computing environment 100 communicate with one another over the network 112. In alternative embodiments, two or more of the components communicate through a dedicated or networked communication channel (not shown) other than the network 112.

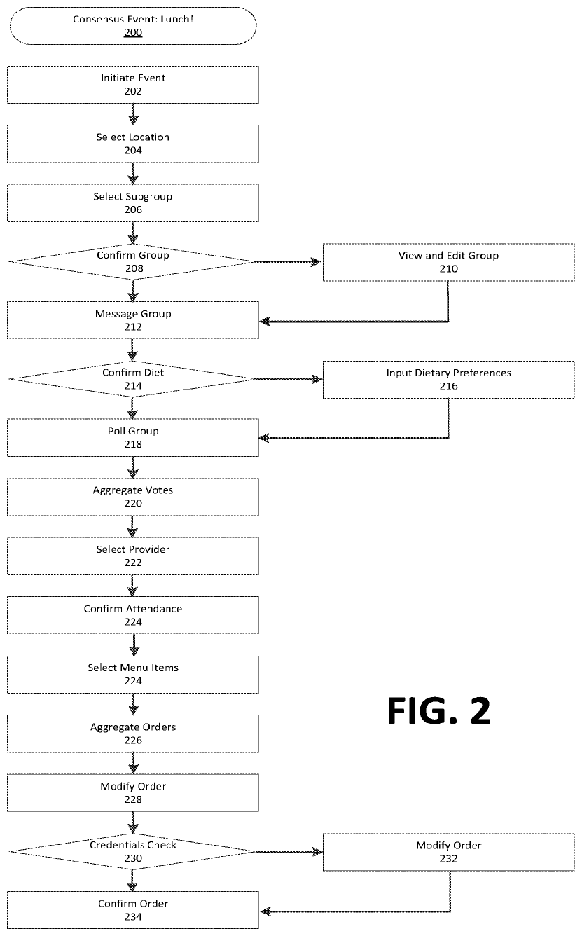

The consensus server 114 comprises a number of “modules,” which refers to hardware components and/or computational logic for providing the specified functionality. An module can be implemented in hardware, firmware, and/or software (e.g., a hardware server comprising computational logic). It will be understood that the named components represent one embodiment of the disclosed method, and other embodiments may include other components. In addition, other embodiments may lack the components described herein and/or distribute the described functionality among the components in a different manner. Additionally, the functionalities attributed to more than one component can be incorporated into a single component. Where the modules described herein are implemented as software, the module can be implemented as a standalone program, but can also be implemented through other means, for example as part of a larger program, as a plurality of separate programs, or as one or more statically or dynamically linked libraries. In any of these software implementations, the modules are stored on the computer readable persistent storage devices of the system 114, loaded into memory, and executed by the one or more processors of the system's computers. The operations of the consensus server 114 and its various components will be further described below with respect to FIG. 2 and the remaining figures.

In some embodiments the consensus server 114 has a front end interface 116 that functions similarly to the application 104 installed on a client device 102, e.g. the front end interface 116 may provide a user interface 108 with a settings module 108 and consensus module 128 that any user with access to the front end interface may use to participate in a consensus event. The front end interface 116 may be accessed via a web browser or via an application installed on a client device. The front end interface 116 may allow device user without the application 104 on their client device (e.g., client device 102d) to interact with the consensus server 114 and participate in the consensus event.

The polling module 118 mediates a poll system between the different client devices 102 during a consensus event. The polling module 118 transmits and receives poll questions and poll responses to the client devices 102 participating in a consensus event. The poll question can be displayed on the application 104 via the user interface 108 and consensus module 110. Each application 104 that receives a poll question may answer the poll question with the consensus module 110 and transmit the response to the consensus server 114 and polling module 118 via the network 112. The polling module 118 may then aggregate the responses into a new set of metadata, store the responses from each user in the user database 126, communicate the response to the suggestion module 120, or communicate the responses to client devices 102 via the network 114. The polling module 118 may communicate with the suggestion module 120 to generate a poll question specific to the client device 102, the user of a client device 102, or the user account based on associated metadata within the environment. In some embodiments, the functionality of the polling module 118 may be incorporated into the consensus module 110 on the client device 102.

In one embodiment, a user during a consensus event may wish to begin a poll to determine a consensus about evening plans and requests polling of the users with the polling module 118 via the consensus module 110. The polling module 118 sends a poll question to the individual users for display on the client device 102 (or front end interface 116) with the content module 110 and user interface 108 via the network 112. Each poll question can be tailored to each specific user based on associated metadata and information about the user within the environment 100. The content module 110 may then interpret a response to the poll question and transmit a response to the polling module 118 via the network 112. The polling module 118 may aggregate and interpret the responses to the poll question from all the users participating in the consensus event. In some embodiments, the polling of users may generate a series of poll questions pertaining to the consensus event and may contain information from previous polling questions. For example, as part of a consensus event the poll question “What city should we go out in?” is asked to a group of users. The aggregate response to the poll question from the users is “New York.” After this, the polling module may ask a follow-up poll question such as “Which club in New York?”

The suggestion module 120 analyzes metadata and information in the environment 100 associated with users or groups of users to generate a list of candidate objects for use during a consensus event. The candidate objects can be generated at any point during a consensus event and may include a list of: preferences, providers, menu items, food items, store items or any other item that is referenced in the metadata within the environment 100. The type of candidate objects generated is dictated by the step of a consensus event requiring a list of suggested objects. For example, if the consensus event is polling users for their preferences, the suggestion module may generate a list of candidate preferences such as: “American,” “Chinese,” and “Smoothies.” Alternatively, if the consensus event is asking the initiating user for the location event, the suggestion module may generate a list of candidate locations such as: “Broadway Location, Conference Room A,” “Park Location, Room 112,” and “Suite 230.” In one embodiment, the suggestions are generated based on associations in the settings module 106, user database 126, provider database 132, provider item database 124, and any other metadata sources within the environment 100. Other embodiments of generating candidate objects comprise manual selection, random generation, or other suitable algorithm-based generation methods.

The ordering module 122 communicates the results of a consensus event of the client devices to the selected provider. In one embodiment, the results of the consensus event may be an item or items to be purchased as a result of the consensus event. The ordering module includes functionality to transfer forms of payment between the selected provider and the client devices. The ordering module 122 may also provide information to assist the provider in completing a transaction for the order, for example by transacting with stored credit card information or providing delivery instructions.

The provider item database 124 stores items associated with a provider that may be presented to a user during a consensus event. The provider items may include services and goods for purchase, or any other item associated with a provider. The provider item database 124 may communicate with the consensus module 110, and suggestion module 120 to facilitate the functionality of those modules. For example, the consensus module 110 may receive an input from a user during a consensus event that requests a search for items in the provider database 124. In one example, the provider item database stores menu items from a plurality of restaurants that can be ordered as a result of a consensus event.

The user database 126 stores information and metadata associated that may be presented to a user during a consensus event or utilized by other modules in the system to facilitate functionality. The user database 126 may include metadata associated with a user, a user account, or a client device. The metadata may include geographic location, payment information, preferences, usage history, security metrics and information, device information, device settings, or any other metadata associated with the user or the user interactions within the environment 100.

The consensus module 128 analyzes information received via the network and consensus module 110 for triggers that will initiate a consensus event. These triggers may be text input from a user while using the application 104, icon selection from a user while using the application 104, text or icon interaction on the front end interface 116, automatic triggers implemented by the modules or modules of the consensus server 114, or any similar trigger that can initiate a consensus event. The consensus module may communicate with the consensus modules on the client devices 102 via the network 112 to facilitate analysis of user inputs. The consensus module 128 may communicate with any module or database of the consensus server 114 to facilitate functionality of the consensus module 128, e.g. the consensus module may access the provider item database 124 during a consensus event.

The security module 130 provides identity management and authentication services to applications executing on the client devices 102. The security module 130 receives and processes authentication requests from untrusted applications 104 executing on the client devices 102. In general, the security module 130 facilitates the delegated authentication of an untrusted application 104 by security protocols associated with any of the client device 102, the consensus server 114, the network 112, information stored in the settings module 106 of the client device 102, and information stored in the user database 126. The security module may maintain a list of previously authenticated applications 104 for subsequent secure communication with the consensus server 114 or the security module 130.

The provider database 124 stores content and metadata associated with providers that may be presented to a user during a consensus event or utilized by other modules in the system to facilitate functionality. The provider database 124 may include metadata associated with a provider, a provider account, or a provider client device. The metadata may include geographic location, payment information, preferences, usage history, security metrics and information, device information, device settings, or any other metadata associated with the provider or the providers interactions with in environment 100.

FIG. 2 illustrates the process flow for an example consensus event 200 between device users via an application on the client devices, according to one embodiment. As an example process flow for the consensus event: Alyx is a user of a client device 102a with an application 104 that uses a consensus module 106. Alyx is organizing a group lunch to be delivered to the office using the “Lunch” consensus event 200 of the consensus module 110 and consensus server 114.

Initiating 202 a consensus event 200 with the consensus module 110 and consensus server 114 using a client device 102 can be accomplished via several methods. In one embodiment, a user of the client device 102 sends a message via the application 104 on the client device. The message may be directly sent to the consensus server 114 to initiate a consensus event 200, e.g. Alyx may type “@kiplunch, initiate lunch.” Alternatively, the message may have several key words within the text that can be interpreted by the consensus module 110 or consensus module 128 as an indicator to initiate a consensus event 200, e.g. Alyx may type “start lunch buy.” Alternatively, the message may be a natural language statement that the consensus module 110 or consensus module 128 interprets to initiate a consensus event 200 using natural language processing, e.g. Alyx may type “Hey team! We should get lunch. I'll organize.” In another embodiment, the consensus event 200 is initiated by a device user interacting with the application 104 on their device 102 via the user interface 108, e.g. Alyx clicking an icon on the user interface that reads “Start Lunch.” This interaction can be a button press, a swipe, a click, a zoom, or any other suitable interaction with the interface to indicate a selection.

Once the consensus event 200 has been initiated 202, the initiating user can then select 204 a location associated with the consensus event. The location of the consensus event may be the geographic location that users participating in the consensus event are associated with, e.g. the location of an office building at which employees of a company work. The location can be selected via several methods. In one embodiment, a user of the client device 102 sends a message via the application 104 on the client device using the consensus module 110 similarly to the initiate step 202, e.g. Alyx may type “@kiplunch Broadway location,” “Broadway for lunch,” or “We will have lunch in the conference room on Broadway,” to select the location for the lunch meeting. In another embodiment, the location is selected by a device user interacting with the application on their device via the user interface, e.g. Alyx clicking an icon on the user interface 108 that reads “902 Broadway, 6^{th} Floor, New York, N.Y. 10010.” In some embodiments, Alyx may select a location based on a map provided by the consensus module 110 or the consensus server 114 via the network 112.

The location that is presented to Alyx via the user interface 108 by the consensus module 110 may be presented to Alyx based on the following: settings in the settings module 106, candidates provided from the suggestion module 120 of the consensus server 114, the security module 130 of the consensus server, the user database 126 of the consensus server, suggestions from another user with the application 104 and consensus module 110 on their client device 102, or from input on the front end interface 116 of the consensus server. At any point during the candidate event, objects or interactions presented to a device user may be based on similar associations.

In an example embodiment, Alyx may have information stored in her settings module 120 detailing her schedule and that she is at work from 9:00 A.M.-6:00 P.M., Monday through Friday. As this consensus event is occurring on a weekday at lunch time the location presented to Alyx by the consensus module 110 is her workplace. In another example embodiment, the security module 130 of the consensus server 112 may only allow an authenticated user to initiate a consensus event or to list authenticated locations. Alyx has previously authenticated her application and her workplace has verified its address with the consensus server so the consensus module provides Alyx with a list of candidate locations. In another example embodiment, the user database 126 may have information stored that Alyx has previously initiated consensus events at similar times to the current consensus event and suggests the locations of the previous current events as the location of the current previous even using the consensus module 110. In another example embodiment, Alyx may have asked another user which room to have the lunch meeting in using the application 104 on their devices 102 or the front end interface 116 on the consensus server. The other user response was recognized by the consensus module 110 on the other user device 102 or consensus server 114 and presented to Alyx as a candidate location by the consensus module 110 on her device 102.

Once a location is selected, the consensus module 110 may ask Alyx to confirm her choice of location. Alternatively, if the location selected by Alyx is not understood by the consensus module 110 as specifying the location, the consensus module may request that Alyx reselect a location. Further, Alyx may enter the new location as a selection into the consensus module 100 during a consensus event. The new location may be typed into the user interface 108, shared via another application 104, or selected off of a map on the client device 102 or front end interface 116.

In some instances, there may be a plurality of users and groups associated with the location selected during the consensus event. After the location has been selected 204, the initiating user can then select 206 a subgroup of users associated with the location for the consensus module to interact with during the consensus event, e.g. a subset of employees that work at the selected office building. The subgroup can be selected via several methods including typing entries or selecting icons, similarly to the initiate 202 step.

For example, Alyx selects her company's location during the select location step 204. All of the device and application users at the company are associated with the location, including users from marketing, human resources, and research. Alyx may be a part of the research group at her company and does not want to invite the marketing and human resources teams to lunch and selects the research users subgroup associated with the location. Similarly to previous descriptions Alyx may type several statements to select the research subgroup: “@kiplunch research group,” “research group lunch,” or “Lunch is only for the research group.” In another embodiment, Alyx selects the subgroup by interacting with the application on her device via the user interface and clicking an icon on the user interface 108 that reads “Research Group.”

Once a subgroup is selected, the consensus module may ask the initiating user to confirm 208 the choice of subgroup. The initiating user may choose to view and edit 210 subgroup members or proceed to message 212 the group. After the subgroup has been edited the initiating user may then message 212 the group. The subgroup can be edited via several methods including typing entries or selecting icons, similarly to the initiate 202 step.

For example, Alex may want to be more selective in the members of the subgroup to invite to lunch and may manually edit the members of the group to invite. Alyx may choose to add, edit or remove members the subgroup using typed messages similarly to previous steps, e.g. Alyx may type “@kiplunch add Jill Banner,” “Don Lighthead remove,” or “Let's make this ladies only, inviting Jill Banner and removing Don Lighthead.” In another embodiment, Alyx views and edits 206 the subgroup by interacting with the application on her device via the user interface, e.g. Alyx clicking an icon on the user interface 108 that reads “Remove Don.”

In some embodiments, the users may use the consensus module 110 to suggest to the initiating user a new user to add to the subgroup. The initiating user can then confirm or reject the addition of a new user based on interactions with the consensus module similarly to previous steps. For example, Jill may respond to the message from the chat interaction module with the message “Confirmed for me. Can we invite Kathryn Mulaney, too?” The consensus module then sends Alyx a message to confirm or reject adding Kathryn to the subgroup.

Once a subgroup is confirmed, the consensus module messages 212 the users of the subgroup using the network 112. The message indicates to each of the selected subgroup members that they have been selected to participate in a consensus event 200 by the initiating user. The message and consensus module 110 may also indicate the selected 204 location and the selected 206 subgroup to the users via the user interface 108 on the client device 102. The messaged users may then choose whether or not to participate in the consensus event by interacting with the consensus module 110 and application 104.

For example, Alyx selected Jill, Barbara, and Caitlin to participate in her lunch meeting. According to one embodiment, the consensus module sends a message to the subgroup saying “Alyx is organizing lunch for the research team and Jill at the Broadway location.” In some embodiments the members of the subgroup can respond to this message with their intention to attend the lunch meeting using methods previously described, e.g. Jill type “I can attend,” Barbara types “@kiplunch confirm” and Caitlin clicks an icon stating “Attending.”

The consensus module 110 may confirm via the settings module 106 of the user device or the user database 126 of the consensus server if each subgroup member has previously associated dietary restrictions. If dietary restrictions for the subgroup member already exist within the environment 100, the consensus module proceeds to poll the subgroup member. If dietary restriction for the subgroup member does not exist, the consensus module allows the user to input 216 their dietary restrictions. The dietary restrictions can be edited via several methods including typing entries or selecting icons, similarly to the initiate 202 step. The new dietary restrictions for a user are stored on the client device 102 in the device settings module 106 and on the consensus server 114 in the user database 126. In some embodiments, the storage of the dietary restrictions may be disallowed by security settings in the security module 130 of the consensus server or the settings module 106 of the user device 102.

For example, Jill is planning to participate in lunch using the consensus module 110 and consensus server for the first time and has no known dietary restrictions in the environment 100. The consensus module messages Jill asking her for her dietary restrictions. Jill may type “@kiplunch vegetarian gluten-free,” “Vegetarian and Gluten-Free,” or “I am a vegetarian and prefer not to eat gluten” to select her dietary restrictions. In another embodiment, Jill selects her dietary restrictions by interacting with the application 104 on her device 102 via the user interface 108, e.g. Jill clicks the icon on the user interface 108 that reads “Vegetarian.” Jill's setting module 106 allows for her preferences to be stored locally, but does not update the user database 126 on the consensus sever 114.

The consensus module then polls 218 subgroup members as to which provider they would like to use for the consensus event 200 using the polling module 118. The consensus server 214 generates candidate poll questions using the suggestion module 120 for each user based on dietary restrictions, user settings, information about the user stored in the user database 126, the security module 130, the provider item database 124, and suggestions from other users. The consensus module 110 provides for display suggestions for preferences associated with each user. The users in the subgroup select a preference from the suggestions or enter a different preference that is not suggested, similarly to previous steps. In some embodiments, the users of the subgroup are able to search for a provider that is not suggested using the consensus module 110 and consensus server 114 before selecting it during the poll.

For example, Alyx may have no dietary restrictions, and the settings module 110 and user database 126 show a previous selection of “Sushi” during “Lunch” consensus events. The consensus module 110 provides a list of candidate preference suggestions generated by the suggestion module 120 via the user interface 108: “Sushi,” “Bento,” “Ramen,” “Surprise-me,” and “Other.” Alyx selects “Bento” by typing “@kiplunch Bento” into the user interface. Jill has the dietary restrictions of vegetarian and gluten-free and no known previous associations or preferences in the environment. The consensus module 110 provides candidate preference suggestions: “Salad,” “Chinese,” “Smoothies,” “Surprise-me,” and “Other.” Jill selects “Salad” by clicking an icon on her user interface to indicate her preference for the lunch meeting provider.

The votes of the subgroup members as to their preferences for the provider are aggregated 220 using the polling module 118 of the consensus server. The results of the poll may be stored in the user database 126, the provider database 132, or be shared with the suggestion module 120 to generate candidate a list of providers associated with the preferences. The suggestions module 120 may generate a list of candidate providers that best caters to all of the preferences indicated by the subgroup members based on the received preferences of the subgroup members, the provider item database 124, and any other metadata associated with the consensus event. The polling module 120 may send the aggregated poll results and suggested providers to the initiating user.

For example, the users in Alyx's subgroup may have indicated “vegetarian” and “gluten-free” dietary restrictions and “Bento,” “Salad,” “Surprise-me,” “Chinese,” and “American” as provider preferences. The polling module receives dietary and provider preferences and generates a list of potential providers to provide for display to Alyx. The polling module sends the list of providers and metadata associated with the providers to Alyx via the network.

The initiating user selects 222 a provider from the list received from the polling module 118 or enters a provider not indicated on the list for selection using the application 104 and consensus module 110. The provider can be similarly selected via several methods.

For example, after viewing a list of candidate providers generated by the suggestion module Alyx selects the Pan-Asian Bistro for her lunch meeting. Alyx may type “@kiplunch choose Pan-Asian Bistro,” “Select Pan-Asian Bistro,” or “I'd like to try Pan-Asian Bistro” to select the Pan-Asian Bistro as the provider. In another embodiment, Alyx selects Pan-Asian Bistro by interacting with the application on their device via the user interface, e.g. Alyx clicks an icon on the user interface 108 that reads “Pan-Asian Bistro.”

Following the selection of the provider by the initiating user, the consensus module 110 and consensus server 114 indicates the selected provider to the users of the subgroup via the network 114. The subgroup members can confirm 224 their attendance using the consensus module 110. The consensus module can indicate to other users of the subgroup which subgroup members have confirmed or rejected the selected provider. In some embodiments, the consensus module 110 gives the initiating user the ability to select a different provider based on the number of confirmations provided by the subgroup.

For example, the consensus module sends the subgroup members the message “Alyx has selected Pan-Asian Bistro for lunch. Currently Alyx is confirmed” Jill may see this message and indicate that she will attend lunch by typing, “Confirm lunch” or selecting an icon that reads “Confirm.” The consensus module may send a new message to the subgroup indicating her confirmation. “Alyx has selected Pan-Asian Bistro for lunch. Currently Alyx and Jill are confirmed.”

After the users have confirmed attendance, the consensus module then presents the attendees a set of menu items to select 224. The consensus server 214 generates candidate menu items using the suggestion module 120 for each attendee based on dietary restrictions, user settings in the user settings module 106, information about the user stored in the user database 126, the security module 130, the provider item database 124, and suggestions from other users. The consensus module 110 provides for display on the client device for each user suggestions for menu items suited to that particular device user. Each attendee selects menu items or enters a different menu items that are not suggested, similarly to previous steps. In some embodiments, attendees are able to search for a menu item that is not suggested using the consensus module 110 and consensus server 114 before selecting it during the poll. In still other embodiments, the attendees are able to see various types of menus and menu items by selecting various icons presented via the user interface 108. In some embodiments, certain menu items presented to the user necessitate additional menu items selections based on the first item selected, e.g. choosing a dressing for a salad.

For example, Jill has the dietary restrictions of vegetarian and gluten-free, has previously indicated a preference for salads during this consensus event, and Pan-Asian Bistro was selected as the provider. The suggestion module 120 uses this information and the provider item database 124 to generate a list of candidate menu items to display to Jill: “Chinese Noodle Salad,” “Vegetarian Spring Rolls,” “Grilled Sprouts Burger.” Jill may select a menu item by typing “@kiplunch select Grilled Sprouts Burger,” “Select Grilled Sprouts Burger,” or “I'd like to try the Grilled Sprouts Burger.” Jill may also selects a menu item by clicking an icon on her user interface to indicating the “Grilled Sprouts Burger.” Jill may then select the toppings for her Grilled Sprouts Burger by interacting with subsequent menu items provided by the suggestions module 120.

After the attendees have selected menu items 224, the individual orders are aggregated 226 into a single order by the ordering module 122. The aggregated orders are provided to the initiating user who may then modify the order using the consensus module 110 and application on their device 102.

For example, Alyx's group concludes ordering as individuals, the ordering module 122 aggregates the individual orders, and provides Alyx with the aggregate order to modify via the application 104 and consensus module 110. Alyx's group order includes two burgers, three sushi rolls, a bento, and a cocktail. Alyx chooses to modify the order by removing the cocktail by typing “Remove cocktail” into the user interface or selecting an icon indicating its removal.

The consensus module may check the credentials of the initiating user 230 who may not have the privileges necessary to confirm an order from the consensus event. The consensus module 110 may send the results of the consensus event including the aggregated and modified order to a user with the appropriate credentials for confirmation of the order and payment. The order may be modified by the credentialed user similarly to the previous modify step. After the order has been finalized the credentialed user may select a form of payment and the confirmed order may be sent to the selected provider using the ordering module 122. In some embodiments, the payment information may be stored in the settings module 106 or the user database 126. In other embodiments the ordering module may specific device users for payment information for at least part of the order via consensus module 110 and network 114.

For example, Alyx has concluded modifying the order but a credential check by the consensus module 110 indicates that she may not use the research group credit-card to pay for lunches. Alyx indicates that she has completed modifying the order and sends the order to her supervisor for confirmation via interaction with the application 104 and consensus module 110. After reviewing the order Alyx's supervisor confirms the order and enters credit card information for payment via interaction with the application 104 and consensus module 110. Alyx's supervisor sends the order to the selected provider via the order module 122. In an alternative embodiment, Alyx does not need to request confirmation from her supervisor and send the order directly after she enters payment information.

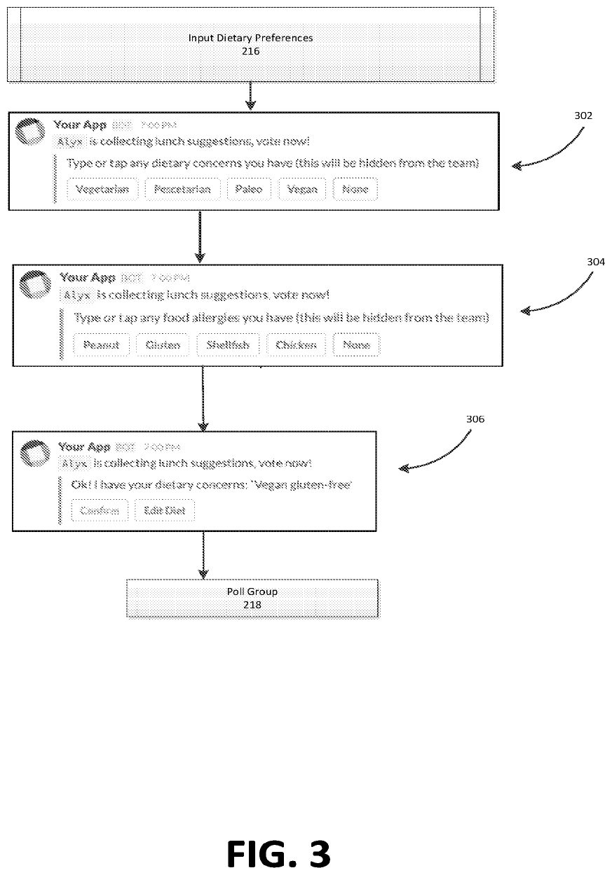

FIG. 3 illustrates an embodiment of inputting 216 dietary restrictions with the consensus module 110 via the user interface 108 on a client device 102. The consensus module 110 provides for display a list of dietary concerns 302 that a member of the subgroup may select. In one embodiment, the list can be provided via the network and the consensus server 114. The user may type into the consensus module 110 one or more of the items on the list to indicate a preference. Additionally, the user may tap or click any of the icons indicating the dietary restrictions as displayed on the user interface 108.

The consensus module 110 provides for display a list of food allergies 304 that a member of the subgroup may select. In one embodiment, the list can be provided via the network and the consensus server 114. The user may type into the consensus module 110 one or more of the items on the list to indicate a preference. Additionally, the user may tap or click any of the icons indicating the dietary restrictions as displayed on the user interface 108.

After the dietary concerns and food allergies have been entered, the consensus module saves the input in the user settings module and user database. The consensus module 110 queries the user for confirmation or further editing of the dietary concerns 306. After the preferences have been input, the consensus module polls 218 the subgroup.

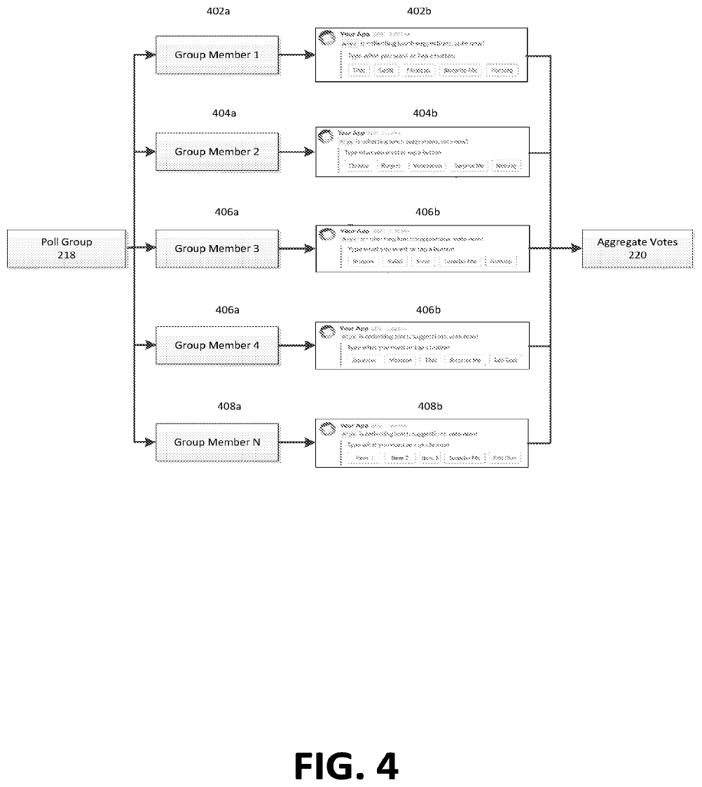

FIG. 4 illustrates an embodiment of polling 216 candidate preferences with the consensus module 110 and polling module 118 via the user interface 108 on various client devices. The first subgroup member 402a is provided with a list of suggested preferences associated with dietary restrictions, user settings, and information about the user in the user database. The suggestion module 120 may generate the list of candidate preferences. Similarly, the second and subsequent subgroup members are provided with a list of candidate preferences independently associated with each subgroup member based on the dietary restrictions, user settings, and information about the user in the user database. The user may type into interface 108 one or more of the items on the list to select a preference. Additionally, the user may tap or click any of the icons displayed on the user interface 108 to select a preference.

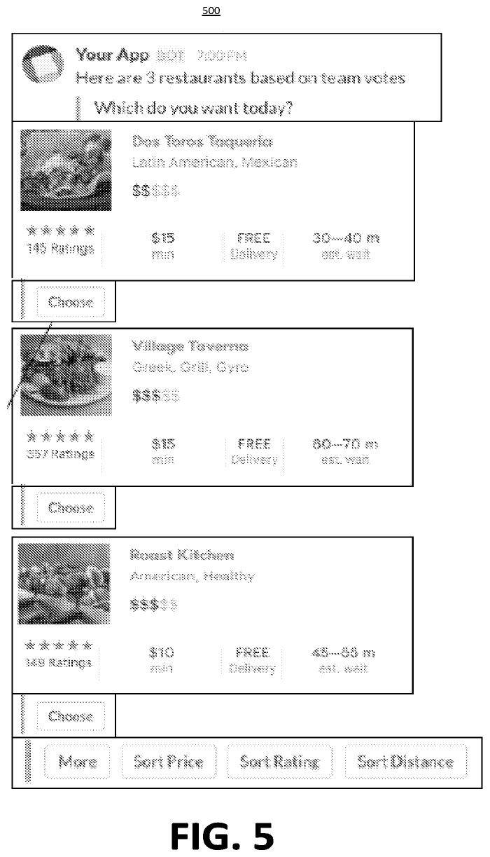

FIG. 5 illustrates an embodiment of selecting 222 a provider from a list of candidate providers 500 based on the aggregated 220 preferences of the subgroup members polled 218 by the polling module 118. The list of candidate providers may include metadata about each provider including: reviews, absolute location, proximity to the selected location, time until items can be provided, service fees, average prices, and minimum prices. The list of choices can be sorted based on any aspect of the metadata, e.g. closest to furthest and least expensive to most expensive. The user may type into interface 108 one or more of the items on the list to select the provider. Additionally, the user may tap or click any of the icons displayed on the user interface 108 to select the provider. In some embodiments, the candidate provider list can be searched for keywords or providers not currently displayed on the user interface.

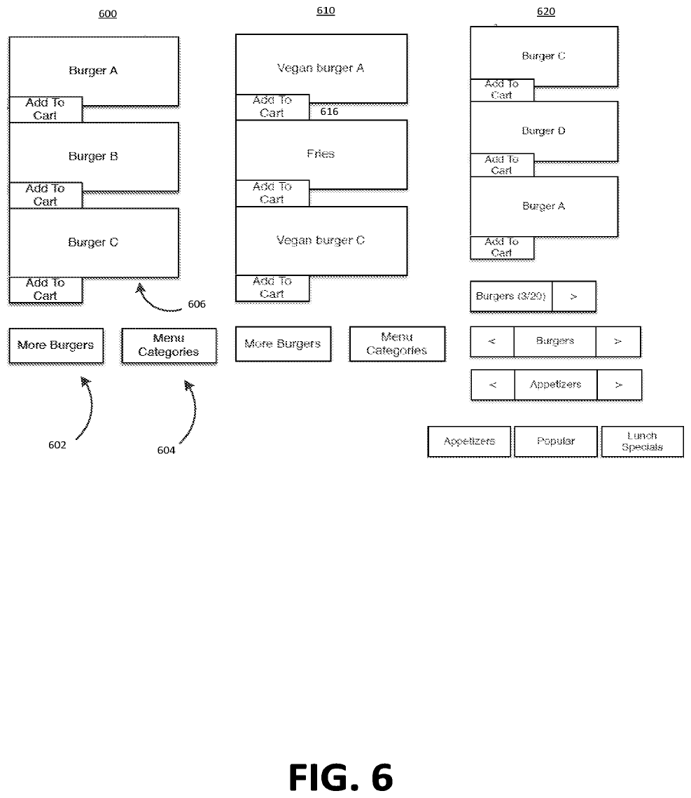

FIG. 6A-6C illustrate embodiments of selecting 224 menu items by the subgroup members using the consensus module on a client device. After the provider is selected, the consensus server 114 uses ordering module 112 and the provider item database 124 to provide menu items for selection to the subgroup members on various client devices 102a-102c via the user interface and consensus modules. The menu items may be selected and sorted based on the dietary restrictions of the users, information in the settings module 106, analysis by the suggestion module 120, and the user database 126. The menu items may include metadata about each menu item including: preparation time, review, prices, nutritional data, ingredients, and similar. The list of menu items can be sorted based on any aspect of the metadata. The user may type into the consensus module 110 one or more of the menu items on the list to indicate a preference. The user may type into interface 108 one or more of the menu items on the list to select an item to order. Additionally, the user may tap or click any of the icons displayed on the user interface 108 to select a menu item to order.

For example, the menu items in 600 are for a subgroup member with no dietary preference and information in the user database indicating a predilection for ordering hamburgers. The user may choose to view more burgers 602 on this list or to change menu categories 604. Once the user has made their selection the user can select ‘add to cart’ 606 to order the menu item. Similarly, the menu items in 610 are for a subgroup member with a vegan dietary preference and the menu items of 620 are for a user whose user settings dictate displaying a more extensive menu items list.

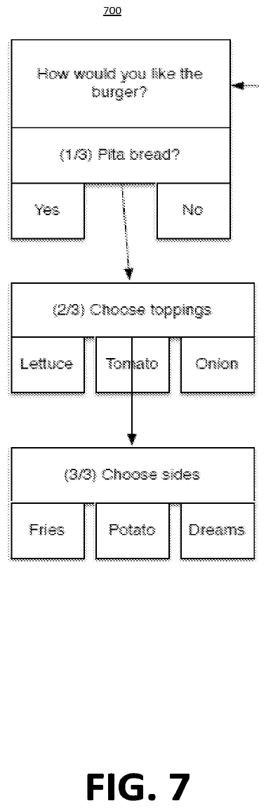

FIG. 7 illustrates an embodiment of additional menu items displayed after a menu item has been selected. When a user selects a menu item to ‘add to cart’ the item may require more information before it can be added to the cart. The user interface and consensus module may provide the user with additional options to select before adding the item to the cart. 700 demonstrates the additional items presented to the user after selecting a hamburger to add to the cart. The user may type into interface 108 one or more of the items on the list to select menu items. Additionally, the user may tap or click any of the icons displayed on the user interface 108 to select the menu items.

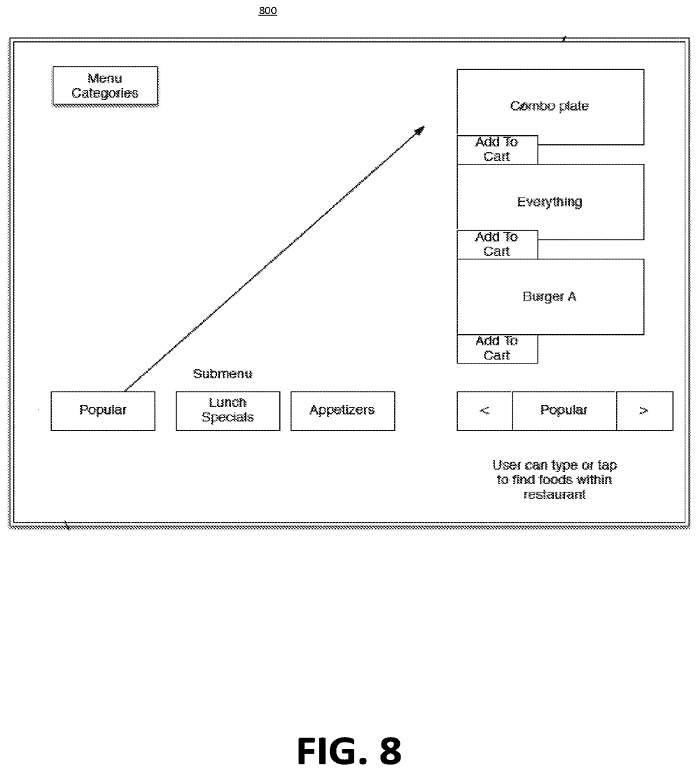

FIG. 8 illustrates an embodiment of additional menu items presented via the user interface 108 of a client device 102 after selection of a menu category 604. The user selects the menu category with the consensus module and the user interface displays a new set of menu items based on the user selection. In the illustrated embodiment 800, the user selects ‘Popular’ as the menu category and the menu items available to select are resorted using a popularity metric. The user may type into the user interface one or more of the items on the list to select the menu items. Additionally, the user may tap or click any of the icons displayed on the user interface 108 to select the menu items.

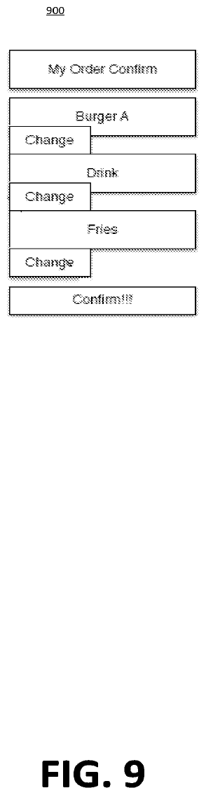

FIG. 9 illustrates an embodiment of confirming 234 an order from the menu items added to the cart by the client device users. 900 illustrates the menu items selected by the user to add to the cart. The user may type into the interface 108 one or more of the items on the list to select menu items to edit the menu item or remove it from the cart. Additionally, the user may tap or click any of the icons displayed on the user interface 108 to edit the menu item or remove it from the cart.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method for generating a consensus about a topic, the method comprising:
providing a consensus server;
receiving inputs from at least three client devices, each of the at least three client devices having a user interface for entering an input;
initiating a consensus event based upon the inputs;
transmitting the consensus event to the at least three client devices; and
displaying the consensus event on each of the at least three client devices.

2. The computer-implemented method of claim 1, wherein the user interface on each of the least two client devices includes an software application that directly questions users, groups polling users, provides suggestions to users about the consensus event, gathers votes from users as parts of the consensus, or combinations thereof.

3. The computer-implemented method of claim 2, wherein the consensus event includes determining what occurs at the event, selecting a location for the event, inviting users to participate in the event, selecting a provider for the event, selecting items for the event, paying for the event, and combinations thereof.

4. The computer-implemented method of claim 1, wherein the at least three client devices are selected from a group consisting of a desktop computer, laptop computer, smart phone, personal digital assistant, and combinations thereof.

5. The computer-implemented method of claim 1, wherein the at least three client devices include software applications that execute on a processor of each of the at least three client devices.

6. The computer-implemented method of claim 5, wherein the software applications are associated with a unique identifier and performs various functions for interacting with other applications and for generating a consensus with the consensus server.

7. The computer-implemented method of claim 5, wherein the software applications are selected from a group consisting of a web browser, networking application, messaging application, gaming application and media consumption application.

8. The computer-implemented method of claim 5, wherein the software applications are linked to user accounts on the consensus servicer associated with each of the at least three client devices.

9. The computer-implemented method of claim 5, wherein the software applications include a settings module that includes metadata and information associated with each of the device users.

10. The computer-implemented method of claim 9, wherein the metadata and information associated with each of the device users includes inter-device security metrics, network security metrics, authentication protocols, user account information and preferences, client device information and preferences, device user information and preferences, client device information and preferences, device user information preferences, a record of preferences and changes, location based information, and combinations thereof.

11. The computer-implemented method of claim 1, wherein the steps are automated on a processor.

12. A computer implemented system for generating a consensus, the computer implemented system comprising:
a consensus server having a processor and a memory having program code embodied therewith, the program code executable by the processor, the consensus server configured to generate a consensus event; and
at least three client devices in communication with the consensus server, each of the at least three client devices having a user interface for entering an input,
wherein the program code executable by the processor on the consensus server:
receives inputs from at least three client devices;
initiates a consensus event based upon the inputs; and
transmits the consensus event to the at least three client devices,
wherein the consensus event is displayed on each of the at least three client devices after being transmitted from the consensus server.

13. The computer implemented system of claim 12, wherein the user interface on each of the least three client devices includes an software application that directly questions users, groups polling users, provides suggestions to users about the consensus event, gathers votes from users as parts of the consensus, or combinations thereof.

14. The computer implemented system of claim 13, wherein the consensus event includes determining what occurs at the event, selecting a location for the event, inviting users to participate in the event, selecting a provider for the event, selecting items for the event, paying for the event, and combinations thereof.

15. The computer implemented system of claim 12, wherein the at least three client devices are selected from a group consisting of a desktop computer, laptop computer, smart phone, personal digital assistant, and combinations thereof.

16. The computer implemented system of claim 12, wherein the at least three client devices include software applications that execute on a processor of each of the at least three client devices.

17. The computer implemented system of claim 16, wherein the software applications are associated with a unique identifier and performs various functions for interacting with other applications and for generating a consensus with the consensus server.

18. The computer implemented system of claim 16, wherein the software applications are selected from a group consisting of a web browser, networking application, messaging application, gaming application and media consumption application.

19. The computer implemented system of claim 16, wherein the software applications are linked to user accounts on the consensus servicer associated with each of the at least three client devices.

20. The computer implemented system of claim 16, wherein the software applications include a settings module that includes metadata and information associated with each of the device users.
